(19) United States
(12) Patent Application Publication
(10) Pub. No.: US 2025/0026441 A1
(43) Pub. Date: Jan. 23, 2025

(54) Electric Power Generation Unit for a Bicycle, Drivetrain and Bicycle

(71) Applicant: ORA DRIVE GmbH, Ober-Ramstadt (DE)

(72) Inventor: Miha Erjavec, Prebold (SI)

(21) Appl. No.: 18/775,038

(22) Filed: Jul. 17, 2024

(30) Foreign Application Priority Data
Jul. 18, 2023 (DE) 102023118950.6

(51) Int. Cl. B62M 6/55; B62M 6/45; B62M 11/14

(52) U.S. Cl. CPC B62M 6/55; B62M 6/45; B62M 11/14

(57) ABSTRACT

An electric power generation unit for a bicycle comprises a pedal shaft with pedals and an electric generator with a rotor and a stator, wherein the axis of rotation of the rotor is arranged with a parallel offset to the pedal shaft. The electric power generation unit further comprises a gearbox configured to transmit torque from the pedal shaft to the rotor of the electric generator. The electric power generation unit further comprises a housing comprising at least the electric generator and the gearbox, and/or the axis of rotation of the rotor is arranged with a parallel offset to a powered wheel of the bicycle.

### CROSS-REFERENCE TO RELATED APPLICATION

This application claims priority to and the benefit of German Patent Serial No. 10 2023 118 950.6 filed Jul. 18, 2023, the entire disclosure of which is hereby incorporated by reference

The invention relates to an electric power generation unit for a bicycle. The electric power generation unit comprises a pedal shaft with pedals and an electric generator powered by the pedal shaft

### BACKGROUND

Bicycles with electric motors are playing an increasingly important role in the field of micromobility, especially last-mile mobility. On so-called pedelecs, the electric motor only supports the rider when the rider pedals the pedelec. With e-bikes, the electric motor powers the e-bike even when the rider is not pedaling. For example, chainless electrically powered bicycles are known in which there is no chain between a pedal shaft and a powered wheel of the bicycle

### PRIOR ART

A chainless electrically powered bicycle is known from U.S. Pat. No. 8,997,910 B2. An electric generator arranged coaxially to a pedal shaft is powered by the pedal shaft. Electrical energy generated by the electric generator is supplied to an electric motor arranged in the hub of a rear wheel to power the rear wheel.

DE 10 2020 102 986 A1 discloses a pedal generator of a drivetrain for an e-bike. The generator is arranged coaxially to a pedal shaft and is connected to the pedal shaft via a two-stage planetary gearset.

U.S. Pat. No. 11,459,060 B2 discloses an electrically powered bicycle. The bicycle has an electric generator arranged in a hub of a rear wheel, which is connected to a pedal shaft via a chain and is powered by the pedal shaft.

### SUMMARY OF THE INVENTION

It is an object is to provide an electric power generation unit for a bicycle which is compact and has a high-power density.

This object is achieved by an electric power generation unit having the features defined in claim 1. Advantageous embodiments are given in the dependent claims.

The proposed electric power generation unit for a bicycle comprises a pedal shaft with pedals and an electric generator with a rotor and a stator, wherein the axis of rotation of the rotor is arranged with a parallel offset to the pedal shaft. The electric power generation unit further comprises a gearbox configured to transmit torque from the pedal shaft to the rotor of the electric generator. The electric power generation unit further has a housing encloses at least the electric generator and the gearbox, and/or the axis of rotation of the rotor is arranged with a parallel offset to a powered wheel of the bicycle.

In the proposed electric power generation unit, the electric generator is arranged with a parallel offset to the pedal shaft. The torque of the pedal shaft is transmitted through the gearbox to the rotor of the electric generator. This generates electrical energy to power the bicycle from the mechanical energy supplied to the electric power generation unit via the pedal shaft. At least the electric generator and the gearbox form a structural unit, which may be enclosed by the housing. The arrangement of the electric generator with parallel offset allows the electric power generation unit to be designed to be light and compact and thus, to achieve a high-power density.

In the present document, a bicycle is understood to mean an at least two-wheeled vehicle, but also a three- or four-wheeled vehicle, i.e. a multi-track vehicle. The proposed electric power generation unit can be used in a chainless bicycle in which no chain is arranged between the pedal shaft and a powered wheel of the bicycle. In such a chainless bicycle, the powered wheel may for example be powered by an electric motor which is arranged in a hub of the powered wheel or a frame of the bicycle and which is directly or indirectly supplied with electric power by the electric power generation unit.

The electric generator can be either an internal rotor generator or an external rotor generator. The electric generator may be a three-phase asynchronous machine, a brushless DC motor, a permanent magnet synchronous motor or a disk rotor motor, for example a disk rotor permanent magnet synchronous motor. The gearbox may comprise an arrangement of gears, belts and/or chains to transmit the torque from the pedal shaft to the rotor. Embodiments of the gearbox are described below in connection with embodiments. The pedal shaft can be at least partially enclosed by the housing.

In an embodiment, the gearbox comprises at least a first gear stage which can be powered by the pedal shaft. The first gear stage may have a transmission ratio of 1 or less than 1, i.e. the rotational speed of the electric generator is greater than the rotational speed of the pedal shaft (overdrive). The first gear stage is described in more detail below in connection with further embodiments.

In another embodiment, the first gear stage comprises a gearwheel transmission, for example a spur gear transmission or a helical gear transmission. At least one gearwheel of the first gear stage may be arranged coaxially to the pedal shaft. The gearwheel transmission is mechanically simple and allows slip-free transmission of the torque away from the pedal shaft. This allows the electric power generation unit to work efficiently.

In another embodiment, the first gear stage comprises a chain transmission or belt transmission. For example, the first gear stage comprises a gearwheel arranged coaxially to the pedal shaft, or a pulley arranged coaxially to the pedal shaft. Chain transmissions and belt transmissions are quieter than a gearwheel transmission, for example. The electric power generation unit can be operated with low noise levels.

In another embodiment, the gearbox comprises a second gear stage, which can be powered by the first gear stage and is configured to power the rotor of the generator. For example, the second gear stage has an output shaft that powers the rotor of the electric generator. The second gear stage may have a transmission ratio of less than 1, i.e. the rotational speed of the electric generator is greater than the rotational speed of the pedal shaft. The second gear stage is described in more detail below in connection with embodiments. Further gear stages and/or impellers may be arranged between the first gear stage and the second gear stage.

In another embodiment, the second gear stage comprises a gearwheel transmission, for example a spur gear transmission or a helical gear transmission. At least one gearwheel of the second gear stage may be arranged coaxially to the axis of rotation of the rotor and/or is connected to the output shaft of the second gear stage. The gearwheel transmission is mechanically simple and allows slip-free transmission of the torque to the rotor of the electric generator. This allows the electric power generation unit to operate the electric generator efficiently.

In another embodiment, the second gear stage comprises a planetary gearset. For example, the planetary gearset comprises a planet carrier, which is powered by the first gear stage, at least one, preferably at least two planets, a ring gear and a sun gear, wherein the ring gear is arranged to be non-rotatable and the sun gear is configured to power the rotor of the electric generator, or wherein the sun gear is arranged to be non-rotatable and the ring gear is configured to power the rotor of the electric generator. The first gear stage may power the planet carrier directly. The planetary gearset, also known as an epicyclic gearing, is a compact gearbox that can have a high transmission ratio. This allows the electric power generation unit to be made even more compact. In another embodiment, the planet carrier can be arranged so that it cannot rotate. In such an embodiment, the ring gear may be powered by the first gear stage and the sun gear powers the rotor. In another embodiment, the second gear stage can comprise one of the following gearboxes: a cycloidal drive, a strain wave gearing (harmonic gearing) or a Wolfrom gearing.

In another embodiment, the gearbox has a transmission ratio of greater than 1. In another embodiment, the gearbox may have a transmission ration of 1/5 or less than 1/5. In another embodiment, the gearbox may have a transmission ration of 1/3 or less than 1/3. The transmission ratio may be greater than or equal to 1/1200, wherein the pedal shaft is the input and the rotor of the electric generator is the output and the transmission ratio is understood as the quotient of the rotational speed of the input divided by the rotational speed of the output. The transmission ratio of the gearbox therefore ensures that the rotational speed of the electric generator is greater than the rotational speed of the pedal shaft. The aforementioned transmission ratios allow the electric generator to be operated at an optimum rotational speed. This increases the efficiency with which the electric power generation unit can generate electrical energy from the mechanical energy supplied to the electric power generation unit via the pedal shaft.

In another embodiment, the electric power generation unit comprises a clutch configured to couple the gearbox to the pedal shaft. The clutch may be arranged coaxially to the pedal shaft. The clutch may be a passive clutch or an actuator-controlled clutch. The passive clutch may be a freewheel or a ratchet and prevents the pedal shaft from being powered. The actuator-controlled clutch is also known as an active clutch and allows the gearbox and the pedal shaft to be separated to prevent the pedal shaft from being powered.

In another embodiment, the electric power generation unit comprises a controller that is configured to control at least the electric generator. Alternatively, or additionally, the electric power generation unit can be connected to an external controller, which is configured to control at least the electric generator. The controller may comprise a frequency converter, which is configured to generate a DC voltage from the AC voltage generated by the electric generator. This allows the electric power generation unit to supply a DC motor with electrical energy, or to charge an energy storage device of the bicycle, for example to charge batteries or capacitors. The controller may be arranged in the housing of the electric power generation unit.

In another embodiment, the electric power generation unit comprises at least one rotation sensor which is arranged and configured to measure a rotor position, a rotational speed and/or a rotational direction of the rotor of the electric generator and/or of the pedal shaft, to generate measurement data corresponding to the measurement and to transmit the measurement data to the controller. In another embodiment, the rotation sensor can be connected to an external controller and is configured to transmit the measurement data to the external controller. The rotation sensor may be a Hall sensor. Based on the rotor position, the rotational speed and/or the direction of rotation of the electric generator and/or the pedal shaft, an electric motor of the bicycle can be controlled, for example in such a way that the rotational speed of the electric motor is proportional to the rotational speed of the electric generator or the pedal shaft. This provides a natural pedaling feel for a chainless bicycle where there is no mechanical connection between the pedal shaft and the powered wheel.

The invention also relates to a drivetrain for a bicycle comprising the electric power generation unit described above and an electric motor which can be powered at least by the electric power generation unit. The electric power generation unit can power the electric motor directly. Alternatively, or additionally, the drivetrain can have an energy storage device that can be charged by the electric power generation unit. The electrical energy stored in the energy storage device can then be used to power the electric motor. The energy storage device comprises, for example, accumulators, batteries and/or capacitors, for example supercapacitors.

The drivetrain has the same advantages as the claimed electric power generation unit. The drivetrain may be supplemented with the features of the dependent claims directed to the electric power generation unit. Furthermore, the electric power generation unit described above may be supplemented with the features described in this document in connection with the drivetrain.

The drivetrain can also include an output shaft configured to transmit mechanical energy to the powered wheel of the bicycle. For example, the output shaft may be powered by the pedal shaft directly or via a gearbox. Alternatively, the output shaft can also be powered by the electric generator, if the electric generator is used as an electric motor. A clutch may be arranged between the electric generator and the output shaft so that the output shaft can be decoupled from the electric generator when the electric generator is not operated as an electric motor. The output shaft can be arranged coaxially, parallel or at any other angle to the pedal shaft. The output shaft may have a gearwheel and be connected to the powered wheel of the bicycle via the gearwheel and a chain. In such an embodiment, an actuator-controlled clutch can be used to decouple the electric generator from the pedal shaft when the bicycle is switched to a purely pedal-powered mode. This prevents unnecessary load when the bicycle is powered by the pedals only.

The invention further relates to a bicycle, for example a chainless bicycle, comprising the above-described drivetrain, wherein the electric motor is arranged and configured to power at least one wheel of the bicycle.

The bicycle has the same advantages as the claimed electric power generation unit and the claimed drivetrain. The bicycle may be supplemented with the features of the dependent claims directed to the electric power generation unit. Furthermore, the electric power generation unit described above may be supplemented with the features described in this document in connection with the bicycle.

### BRIEF DESCRIPTION OF THE DRAWINGS

Embodiments of the invention are hereinafter explained with reference to the Figures.

FIG. 1 is a schematic view of an electric power generation unit for a bicycle according to a first embodiment;

FIG. 2 is a schematic view of an electric power generation unit for the bicycle according to a second embodiment;

FIG. 3 is a schematic view of an electric power generation unit for the bicycle according to a third embodiment;

FIG. 4 is a schematic view of an electric power generation unit for the bicycle according to a fourth embodiment;

FIG. 5 is a schematic view of an electric power generation unit for the bicycle according to a fifth embodiment;

FIG. 6 is a schematic view of an electric power generation unit for the bicycle according to a sixth embodiment;

FIG. 7 is a schematic view of an electric power generation unit for the bicycle according to a seventh embodiment;

FIG. 8 is a schematic view of an electric power generation unit for the bicycle according to an eighth embodiment;

FIG. 9 is a schematic view of an electric power generation unit for the bicycle according to a ninth embodiment; and

FIG. 10 is a schematic view of the bicycle according to an embodiment.

### DETAILED DESCRIPTION OF ILLUSTRATIVE EMBODIMENTS

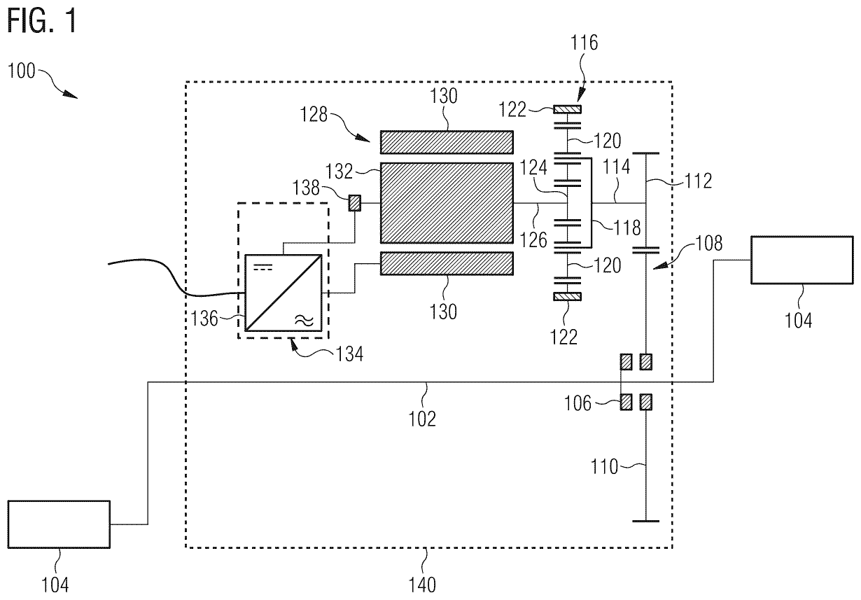

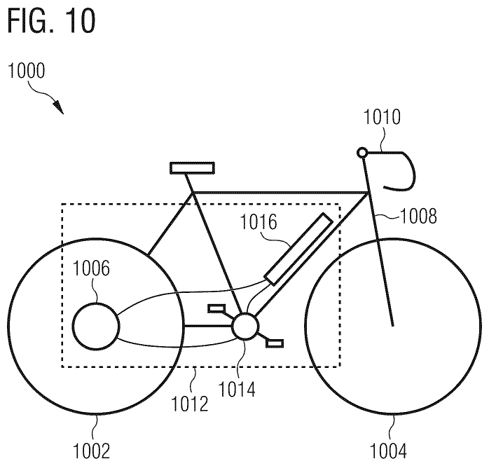

FIG. 1 shows a schematic view of an electric power generation unit 100 for a bicycle 1000 (see FIG. 10) according to a first embodiment.

The electric power generation unit 100 comprises a pedal shaft 102 with pedals 104. With the help of the pedals 104, a user can power the pedal shaft 102 by pedaling and generate a torque. In the embodiment shown, the pedal shaft 102 is connected to a first gear stage 108 by a passive clutch 106 can be used to interrupt the transmission of power from the pedal shaft 102 to the first gear stage 108. The torque is transmitted from the pedal shaft 102 to the first gear stage 108 via the clutch 106. At the same time, the clutch 106 prevents the pedal shaft 102 from being powered.

By way of example, the first gear stage 108 is configured as a gearwheel transmission with two gearwheels 110, 112. A first gearwheel 110 of the first gear stage 108 is arranged coaxially to the pedal shaft 102 and is connected to the pedal shaft 102 via the clutch 106. The first gearwheel 110 of the first gear stage 108 further meshes with a second gearwheel 112 of the first gear stage 108. The second gearwheel 112 is smaller than the first gearwheel 110, i.e. the first gear stage 108 has a transmission ratio of less than 1. The second gearwheel 112 further comprises an output shaft 114, via which the first gear stage 108 is connected to a second gear stage 116.

As an example, the second gear stage 116 is configured as a planetary gearset. The second gear stage 116 comprises a planet carrier 118, which is connected to the output shaft 114 of the first gear stage 108. In the embodiment shown, the planet carrier 118 powers two planets 120 of the second gear stage 116, each of which is in mesh with a ring gear 122 and a sun gear 124 of the second gear stage 116. In the embodiment shown in FIG. 1, the ring gear 122 is arranged non-rotatably and the sun gear 124 is connected to an output shaft 126 of the second gear stage. The output shaft 126 of the second gear stage 116 is coaxially aligned with the output shaft 114 of the first gear stage 108 and is arranged with a parallel offset to the pedal shaft 102. The planets 120 are powered by a rotation of the planet carrier 118 and revolve along the non-rotating fixed ring gear 122 around the sun gear 124. The movement of the planets 120 in turn powers the sun gear 124 and thus the output shaft 126 of the second gear stage 116.

The electric power generation unit 100 comprises an electric generator 128 with a stator 130 and a rotor 132, which is exemplary configured as an internal rotor. The rotor 132 of the electric generator 128 is arranged with a parallel offset to the pedal shaft 102 and is powered by the output shaft 126 of the second gear stage 116. A gearbox is formed by the first gear stage 108 and the second gear stage 116, which transmits torque from the pedal shaft 102 to the rotor 132 of the electric generator 128. The electric generator 128 thus converts mechanical energy, which is generated by pedaling the pedals 104, into electrical energy, which can be used to operate an electric motor 1006 or to charge an energy storage device 1016 of the bicycle 1000 (see FIG. 10).

Controller 134 of the electric power generation unit 100 is configured to control the electric generator 128. In the embodiment shown, the controller 134 comprises a frequency converter 136 for converting the AC voltage generated by the electric generator 128 into a DC voltage. A rotation sensor 138 of the electric power generation unit 100 is connected to the controller 134 and arranged such that the rotation sensor 138 can measure the rotation speed and/or the rotation direction of the rotor 132. The rotation sensor 138 generates measurement data corresponding to the measured rotational speed and/or rotational direction of the rotor 132 and transmits it to the controller 134. Based on the measurement data, for example, the electric motor 1006 of the bicycle 1000 can be controlled such that a motor rotational speed is proportional to the rotational speed of the rotor 132.

In the embodiment shown in FIG. 1, the gearbox formed by the first and second gear stages 108, 116, the electric generator 128, the controller 134, the rotation sensor 138 and at least a part of the pedal shaft 102 are arranged in a housing 140. The electric power generation unit 100 thus forms a compact structural unit with a high-power density. The embodiment shown in FIG. 1 has an overall transmission ratio (i=pedal shaft rotational speed/electric generator rotational speed) of less than 1/5, with a peak torque (maximum torque at the pedal shaft 102) of more than 20 Nm and with a reduced mass moment of inertia (at the pedal shaft 102) of greater than 0.00125 kgm2.

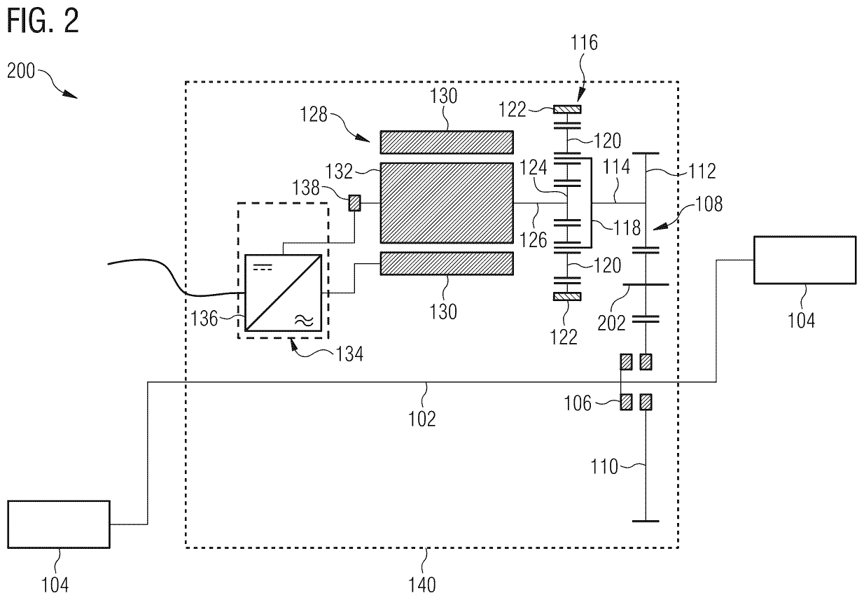

FIG. 2 shows a schematic view of an electric power generation unit 200 for the bicycle 1000 according to a second embodiment.

The electric power generation unit 200 according to FIG. 2 differs from the electric power generation unit 100 according to FIG. 1 in that the first gear stage 108 has an intermediate gear 202. This allows gearwheels with a smaller diameter to be used for the first gear stage 108. As a result, the electric power generation unit 200 can be made even more compact.

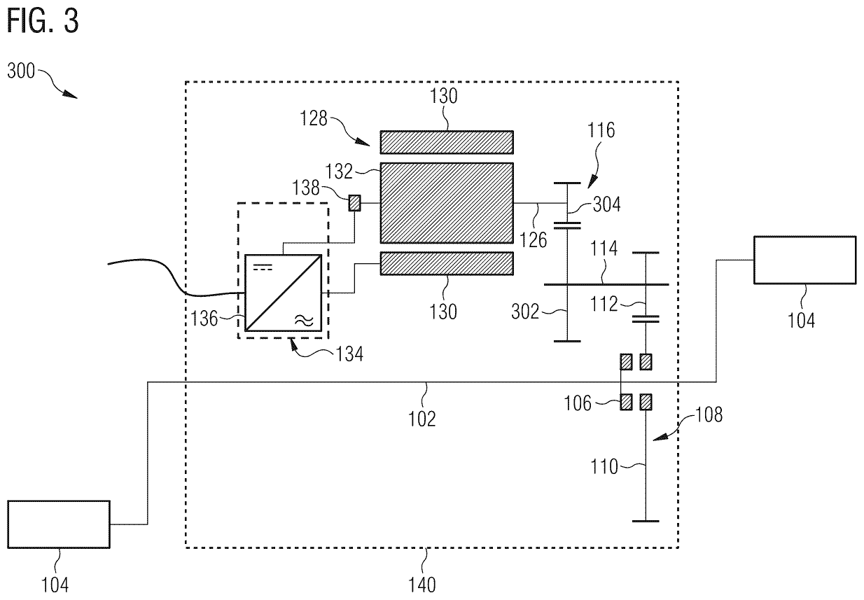

FIG. 3 shows a schematic view of an electric power generation unit 300 for the bicycle 1000 according to a third embodiment.

The electric power generation unit 300 according to FIG. 3 differs from the electric power generation unit 100 according to FIG. 1 in that the second gear stage 116 is configured as a gearwheel transmission. The output shaft 114 of the first gear stage 108 powers a first gearwheel 302 of the second gear stage 116. The first gearwheel 302 of the second gear stage 116 is in mesh with a second gearwheel 304 of the second gear stage 116. The second gearwheel 304 of the second gear stage 116 is connected to the output shaft 126 of the second gear stage 116, which in turn powers the rotor 132 of the electric generator 128. The second gearwheel 304 of the second gear stage 116 is smaller than the first gearwheel 302 of the second gear stage 116, i.e. the second gear stage 116 has a transmission ratio of less than 1.

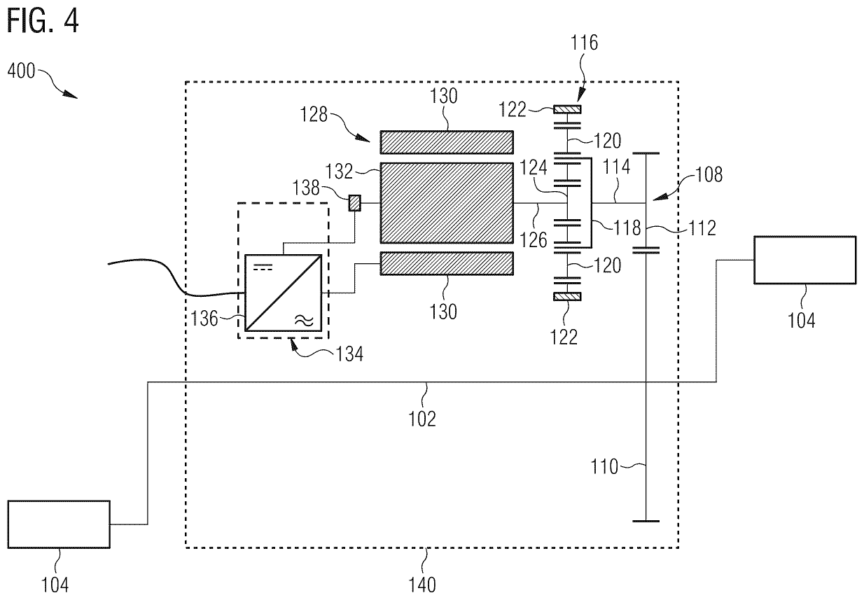

FIG. 4 shows a schematic view of an electric power generation unit 400 for the bicycle 1000 according to a fourth embodiment.

The electric power generation unit 400 according to FIG. 4 differs from the electric power generation unit 100 according to FIG. 1 in that no clutch is arranged between the pedal shaft 102 and the first gear stage 108. The first gearwheel 110 of the first gear stage 108 is directly connected to the pedal shaft 102. By forgoing the clutch 106, the electric power generation unit 400 according to FIG. 4 has fewer moving elements and is simpler in design.

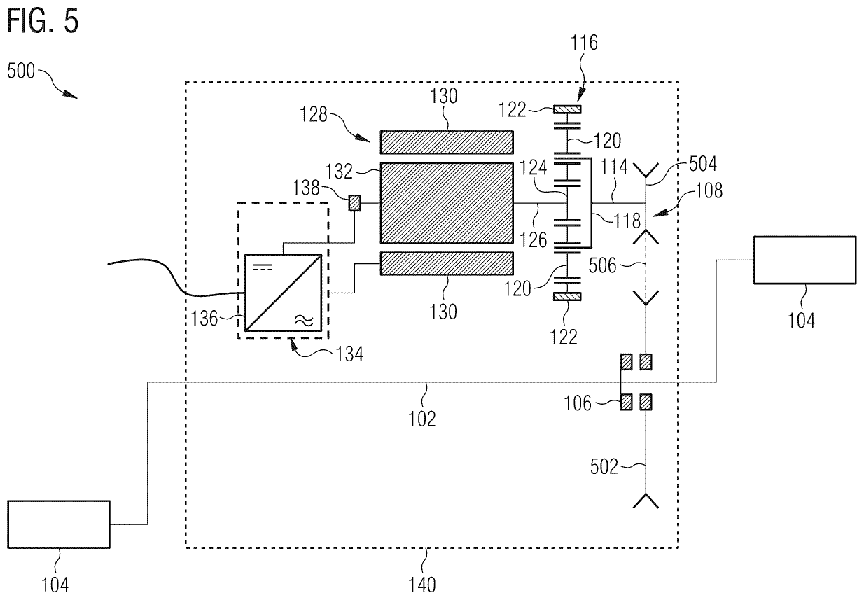

FIG. 5 shows a schematic view of an electric power generation unit 500 for the bicycle 1000 according to a fifth embodiment.

The electric power generation unit 500 according to FIG. 5 differs from the electric power generation unit 100 according to FIG. 1 in that the first gear stage 108 is formed by a chain transmission. A first pinion 502 of the first gear stage 108 is arranged coaxially to the pedal shaft 102 and is connected to the pedal shaft 102 via the clutch 106. A second pinion 504 of the first gear stage 108 is connected to the planet carrier 118 of the second gear stage 116 via the output shaft 114 of the first gear stage 108 and is arranged coaxially with the axis of rotation of the rotor 132. The first pinion 502 is connected to the second pinion 504 via a chain 506. The first gear stage 108 may also be formed by a belt transmission in which the two pinions 502, 504 are replaced by pulleys and the chain 506 is replaced by a belt. Both chain transmissions and belt transmissions can be operated more quietly than a gearwheel transmission.

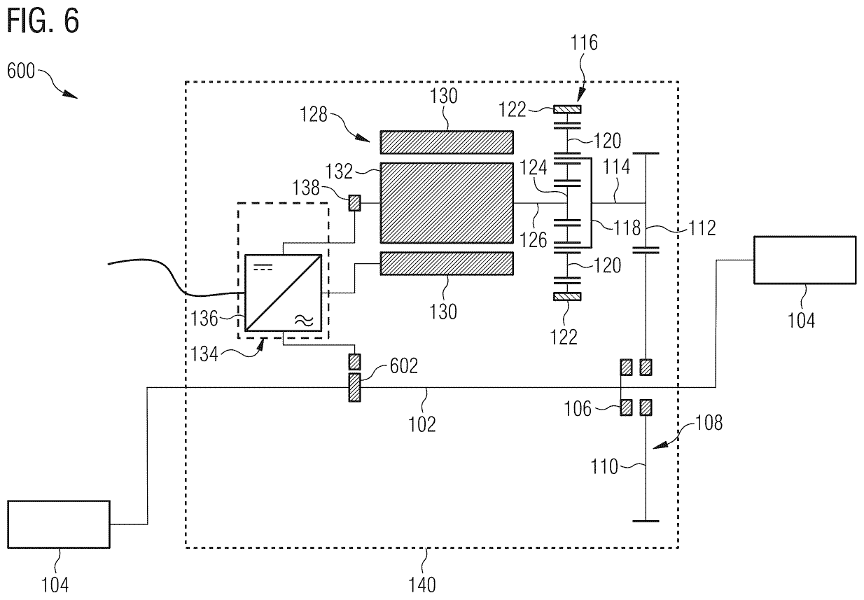

FIG. 6 shows a schematic view of an electric power generation unit 600 for the bicycle 1000 according to a sixth embodiment.

The electric power generation unit 600 according to FIG. 6 differs from the electric power generation unit 100 according to FIG. 1 in that a second rotation sensor 602 is arranged on the pedal shaft 102. The second rotation sensor 602 is configured to measure the rotation speed and/or the rotation direction of the pedal shaft 102, to generate measurement data corresponding to the measurement and to transmit it to the controller 134 of the electric power generation unit 600. Based on the measurement data of the second rotation sensor 602, for example, the clutch 106 can be controlled. Alternatively, or additionally, the electric motor 1006 of the bicycle 1000 can be controlled such that a rotational speed of the motor is proportional to the rotational speed of the pedal shaft 102. This provides a natural pedaling feel for a chainless bicycle. Alternatively, or in addition to the second rotation sensor 602, the electric power generation unit 600 may also include a torque sensor configured to measure a torque of the pedal shaft 102, generate measurement data corresponding to the measurement and transmit the measurement data to the controller 134 of the electric power generation unit 600.

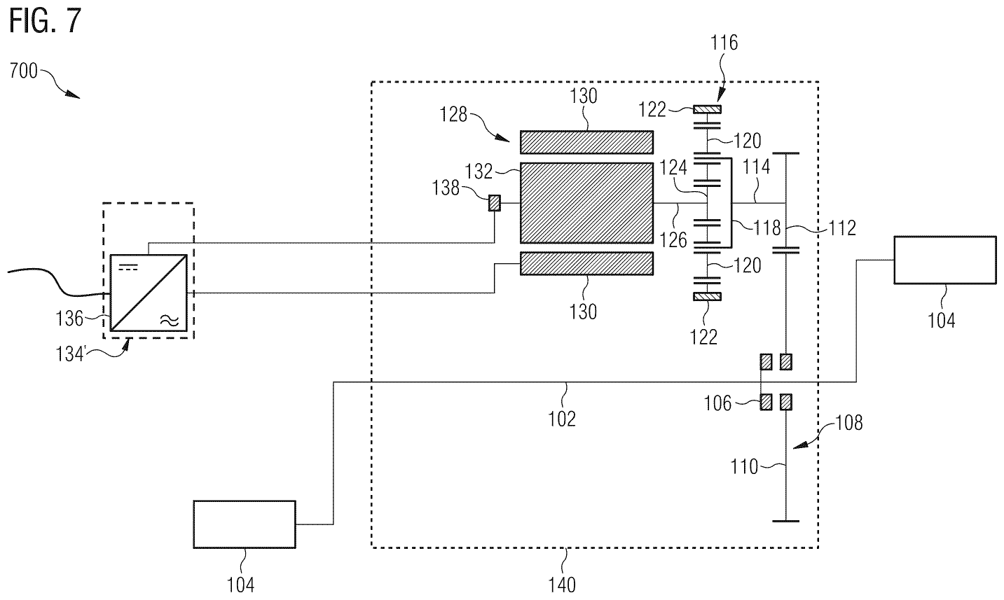

FIG. 7 shows a schematic view of an electric power generation unit 700 for the bicycle 1000 according to a seventh embodiment.

The electric power generation unit 700 according to FIG. 7 differs from the electric power generation unit 100 according to FIG. 1 in that the controller 134′ is arranged outside the housing 140. For example, the controller 134′ is a central controller of the bicycle 1000 which, in addition to the electric generator 128, also controls other functional units of the bicycle 1000, for example the electric motor 1006. Since the controller 134′ is arranged outside the housing 140, the controller 134′ is also referred to as external controller 134′. This external controller 134′ can, for example, be arranged in a handlebar or in a frame of the bicycle 1000.

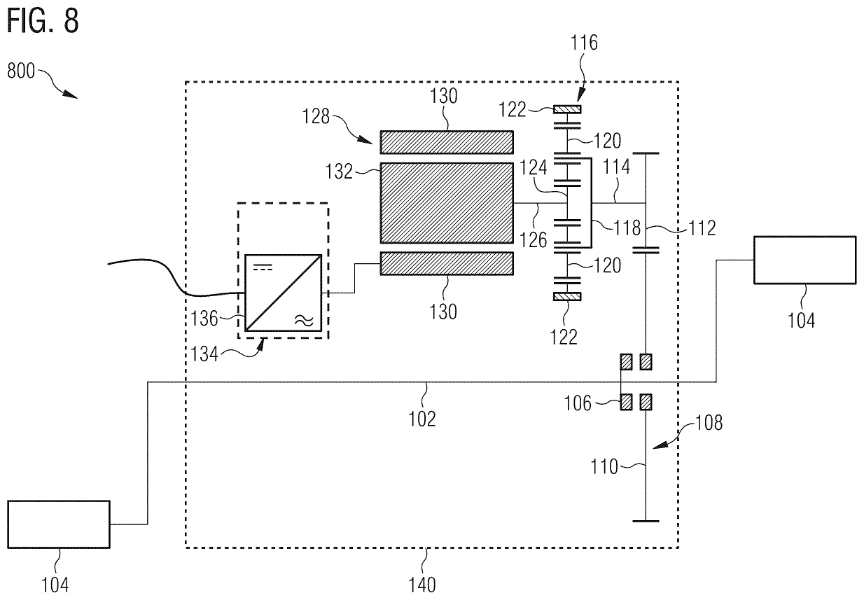

FIG. 8 shows a schematic view of an electric power generation unit 800 for the bicycle 1000 according to an eighth embodiment.

The electric power generation unit 800 according to FIG. 8 differs from the electric power generation unit 100 according to FIG. 1 in that the electric power generation unit 100 does not have a rotation sensor. The controller 134 may be configured to determine the rotational speed of the rotor 132 based on the frequency, voltage, and/or current of the AC voltage generated by the electric generator 128. Based on the determined rotational speed of the rotor 132, the controller 134 may then control the electric motor 1006 of the bicycle 1000 such that the rotational speed of the electric motor 1006 is proportional to the rotational speed of the rotor 132 to produce a natural pedaling feel.

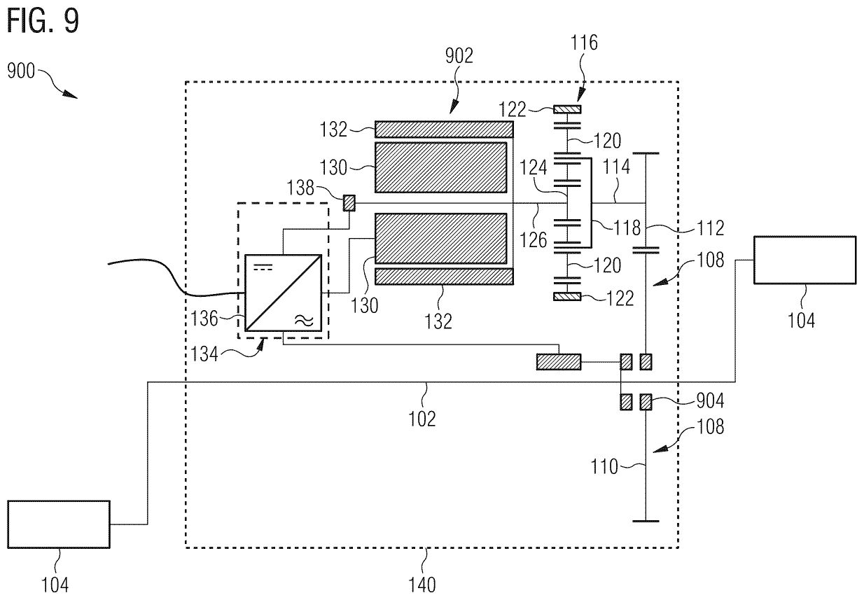

FIG. 9 shows a schematic view of an electric power generation unit 900 for the bicycle 1000 according to a ninth embodiment.

The electric power generation unit 900 according to FIG. 9 differs from the electric power generation unit 100 according to FIG. 1 in that an electric generator 902 comprises an external rotor 132. Furthermore, a clutch 904, which connects the pedal shaft 102 to the first gear stage 108, is formed as an actuator-controlled clutch. The actuator-controlled clutch 904 is connected to the controller 134 and can be controlled by the latter, for example on the basis of the rotational speed and/or the direction of rotation of the rotor 132.

In the embodiments described with reference to FIGS. 1 to 9, at least the pedal shaft 102, the electric generator 128, 902 and the gearbox formed by the first and second gear stages 108, 116 form the electric power generation unit 100, 200, 300, 400, 500, 600, 700, 800, 900. Other elements and features shown in FIGS. 1 to 9 and mentioned in the preceding description may form part of the electric power generation unit 100, 200, 300, 400, 500, 600, 700, 800, 900.

FIG. 10 shows a schematic view of the bicycle 1000 according to an embodiment.

By way of example, the bicycle 1000 is configured as a chainless bicycle with two wheels 1002, 1004. A rear wheel 1002 is powered by an electric motor 1006. A front wheel 1004 is connected to a handlebar 1010 via a steering shaft 1008.

The bicycle 1000 has a drivetrain 1012 comprising an electric power generation unit 1014, an energy storage device 1016 and the electric motor 1006. The electric power generation unit 1014 may be one of the electric power generation units 100, 200, 300, 400, 500, 600, 700, 800, 900 described above. The energy storage device 1016 is arranged on a frame of the bicycle 1000 and may comprise accumulators, batteries and/or capacitors, for example supercapacitors, and is electrically connected to the electric power generation unit 1014, so that the energy storage device 1016 can be charged by the electric power generation unit 1014. The electric motor 1006 is electrically connected to the electric power generation unit 1014 and the energy storage device 1016. The electric motor 1006 can thus be supplied with electrical energy by the electric power generation unit 1014 and the energy storage device 1016.

In the embodiment described with reference to FIG. 10, at least the electric power generation unit 1014 and the electric motor 1006 form the drivetrain 1012. Other elements and features shown in FIGS. 1 to 10 and mentioned in the preceding description may form part of the drivetrain 1012.

In FIGS. 1 to 10, identical or similarly acting elements are designated with the same reference symbols.

### LIST OF REFERENCE SYMBOLS

100 Electric power generation unit
102 Pedal shaft
104 Pedal
106 Clutch
108 Gear stage
110, 112 Gearwheel
114 Output shaft
116 Gear stage
118 Planet carrier
120 Planet
122 Ring gear
124 Sun gear
126 Output shaft
128 Electric generator
130 Stator
132 Rotor
134, 134′ Controller
136 Frequency converter
138 Rotation sensor
140 Housing
200 Electric power generation unit
202 Intermediate gear
300 Electric power generation unit
302, 304 Gearwheel
400 Electric power generation unit
500 Electric power generation unit
502, 504 Pinion
506 Chain
600 Electric power generation unit
602 Rotation sensor
700 Electric power generation unit
800 Electric power generation unit
900 Electric power generation unit
902 Electric generator
904 Clutch
1000 Bicycle
1002, 1004 Wheel
1006 Electric motor
1008 Steering shaft
1010 Handlebar
1012 Drivetrain
1014 Electric power generation unit
1016 Energy storage

1. Electric power generation unit (100, 200, 300, 400, 500, 600, 700, 800, 900) for a bicycle (1000), comprising
a pedal shaft (102) with pedals (104);
an electric generator (128, 902) with a rotor (132) and a stator (130), wherein the axis of rotation of the rotor (132) is arranged with a parallel offset to the pedal shaft (102); and
a gearbox (108, 116) configured to transmit torque from the pedal shaft (102) to the rotor (132) of the electric generator (128, 902),
wherein the electric power generation unit (100, 200, 300, 400, 500, 600, 700, 800, 900) has a housing (140) comprising at least the electric generator (128, 902) and the gearbox (108, 116), and/or
wherein the axis of rotation of the rotor (132) is arranged with a parallel offset to a powered wheel of the bicycle (1000).

2. Electric power generation unit (100, 200, 300, 400, 500, 600, 700, 800, 900) according to claim 1, wherein the gearbox comprises at least a first gear stage (108) which can be powered by the pedal shaft (102).

3. Electric power generation unit (100, 200, 300, 400, 600, 700, 800, 900) according to claim 2, wherein the first gear stage (108) comprises a gearwheel transmission.

4. The electric power generation unit (500) according to claim 2, wherein the first gear stage (108) comprises a chain transmission or belt transmission.

5. Electric power generation unit (100, 200, 300, 400, 500, 600, 700, 800, 900) according to claim 2, wherein the gearbox comprises a second gear stage (116) which can be powered by the first gear stage (108) and is configured to power the rotor (132) of the generator.

6. Electric power generation unit (300) according to claim 5, wherein the second gear stage (116) comprises a gearwheel transmission.

7. The electric power generation unit (100, 200, 400, 500, 600, 700, 800, 900) according to claim 5, wherein the second gear stage (116) comprises a planetary gearset.

8. Electric power generation unit (100, 200, 400, 500, 600, 700, 800, 900) according to claim 7, wherein a planet carrier (118), which is powered by the first gear stage (108), at least one planet (120), a ring gear (122) and a sun gear (124), are comprised in the planetary gearset, wherein the ring gear (122) is arranged to be non-rotatable and the sun gear (124) is configured to power the rotor (132) of the generator, or wherein the sun gear (124) is arranged to be non-rotatable and the ring gear (122) is configured to power the rotor (132) of the generator.

9. Electric power generation unit (100, 200, 300, 400, 500, 600, 700, 800, 900) according to claim 1, wherein the gearbox (108, 116) has a transmission ratio of less than 1, 1/5 or less than 1/5, or 1/3 or less than 1/3.

10. Electric power generation unit (100, 200, 300, 400, 500, 600, 700, 800, 900) according to claim 1, comprising a clutch (106, 904) configured to couple the gearbox (108, 116) to the pedal shaft (102).

11. Electric power generation unit (100, 200, 300, 400, 500, 600, 700, 800, 900) according to claim 10, wherein the clutch is a passive clutch (106), or an actuator-controlled clutch (904).

12. Electric power generation unit (100, 200, 300, 400, 500, 600, 700, 800, 900) according to claim 1, comprising a controller (134) configured to control at least the electric generator (128, 902), and/or connectable to an external controller (134′) configured to control at least the electric generator (128, 902).

13. Electric power generation unit (100, 200, 300, 400, 500, 600, 700, 800, 900) according to claim 12, comprising at least one rotation sensor (138, 602) which is arranged and configured to measure a rotor position, a rotation speed and/or a rotation direction of the rotor (132) of the electric generator (128, 902) and/or the pedal shaft (102), to generate measurement data corresponding to the measurement and to transmit it to the controller (134).

14. A drivetrain (1012) for a bicycle (1000) comprising the electric power generation unit (100, 200, 300, 400, 500, 600, 700, 800, 900) according to claim 1 and an electric motor (1006) drivable by at least the electric power generation unit (100, 200, 300, 400, 500, 600, 700, 800, 900).

15. A bicycle (1000) comprising the drivetrain (1012) according to claim 14, wherein the electric motor (1006) is arranged and configured to power at least one wheel (1002) of the bicycle (1000).
